(19) United States
(12) Patent Application Publication
(10) Pub. No.: US 2003/0007830 A1
(43) Pub. Date: Jan. 9, 2003

(54) Spring loaded detent with angled head

(76) Inventor: Song-Hyuk Bang, Seoul (KR)

Correspondence Address: JAMES R. CWAYNA, 8905 Wood Cliff Rd., Bloomington, MN, 55438, US

(21) Appl. No.: 09/897,468

(22) Filed: Jul. 3, 2001

(51) Int. Cl. F16D 1/00; B25G 3/18; F16B 21/00

(52) U.S. Cl. 403/327

(57) ABSTRACT

A spring loaded detent having a particularly designed, angled head normally utilized in holding and releasably locking two elements such as tubular members together. The angled head assists in the of entrance of the detent into the held member and facilitates the ease of moving the detent against spring force, from its locking position for separation of the members. By increasing the ease of detent entrance into the member to be joined, a positive, yet easily releasable lock is provided between the members. Similarly, the shaping of the head of the detent reduces the pressure required to overcome the locking spring force and allows separation of the members with particular ease.

### RELATED APPLICATIONS

Applicant has not filed any and is not aware of any applications by others that have been filed that should be considered in the prosecution of this application.

### SPONSORSHIP

This invention was not made under any Federal or Independent Organization sponsorship and is the result of the sole efforts of the applicant.

### FIELD OF THE INVENTION

This invention relates generally to spring loaded connection devices for releasably joining two elements such as tubular members and more specifically to the shape of the detent which is carried by the first member and enters an aperture in the second member to securely but releasably join the two with no additional elements such as screws, bolts or the like and more specifically to such a detent having a specifically angled, shaped locking element which eliminates problems of other such detents in the locking and unlocking or releasing shifting of the detent.

### SHORT SUMMARY OF THE INVENTION

A spring loaded detent unit having an arcuately formed mounting member providing a pair of arms, one of which will retain the unit within or to a first member with the other arm providing an outwardly extending locking member of a particular shape which shape is designed to eliminate the normally encountered problems of joining the two members and which will be decidedly easier to compress the detent carrying arm for removal of the same from the second or connected member.

The shape of the detent provides an angular surface which will easily be received into an aperture in the second of the joined members as it will slide upward or outwardly through such aperture after introduction to the aperture and which will also be more easily removed from the second of the joined members as introduction of the formed angle area into the aperture for removal, will allow a sliding force to be applied to the detent which will further depress the detent against the outwardly directed biasing force.

### BACKGROUND AND OBJECTS OF THE INVENTION

The use of spring loaded detents to releasably join two members, often tubular members, is not new to the art. However, the specific shape of such detents has often resulted in locking arrangements that are difficult to utilize in that they require absolute detent to receiving aperture alignment to allow the detent to enter and lock through such aperture. Very often it is necessary to continue to apply inwardly directed pressure to the detent to obtain both locking and unlocking registration of the detent to the joined member. Very often the user will use his or her fingers to accomplish this with the end result being harm to the users fingers.

The applicant provides a spring loaded detent having one side of the detent angularly arranged such that upon even minimal registration of the detent with the receiving aperture, only continued longitudinal motion of the inner to outer member is necessary for the detent to slide into the aperture.

It is therefore an object of the applicant's invention to provide a spring loaded detent having a particularly formed locking portion that will require minimal compression force to locate the same into locking registration and which will, thereafter, generally slide, by the exertion of the spring loaded arms of the member, into the receiving aperture.

It is a further object of the applicant's invention to provide a spring loaded detent having a particularly formed locking portion that will require minimal compression force to provide sufficient movement of the detent through a capturing aperture in the second or joined member to engage an angularly formed portion thereof and allow sidewise or longitudinal movement to continue this initiated inward movement from the locked position.

It is a further object of the applicant's invention to provide a spring loaded detent which is formable and formed from a single, tempered member, to eliminate secondary operations to provide a singular member.

These and other objects and advantages of the applicant's invention will more fully appear from the accompanying description and drawings.

### SHORT DESCRIPTION OF THE DRAWINGS

FIG. 1 is a top plan view of a pair of tubular members releasably joined together with a spring loaded detent embodying the concepts of the applicant's invention;

FIG. 2 is a longitudinal section take substantially along Line 2-2 of FIG. 1;

FIG. 3 is a side view of the spring loaded detent; and,

FIG. 4 is a top view of the spring loaded detent.

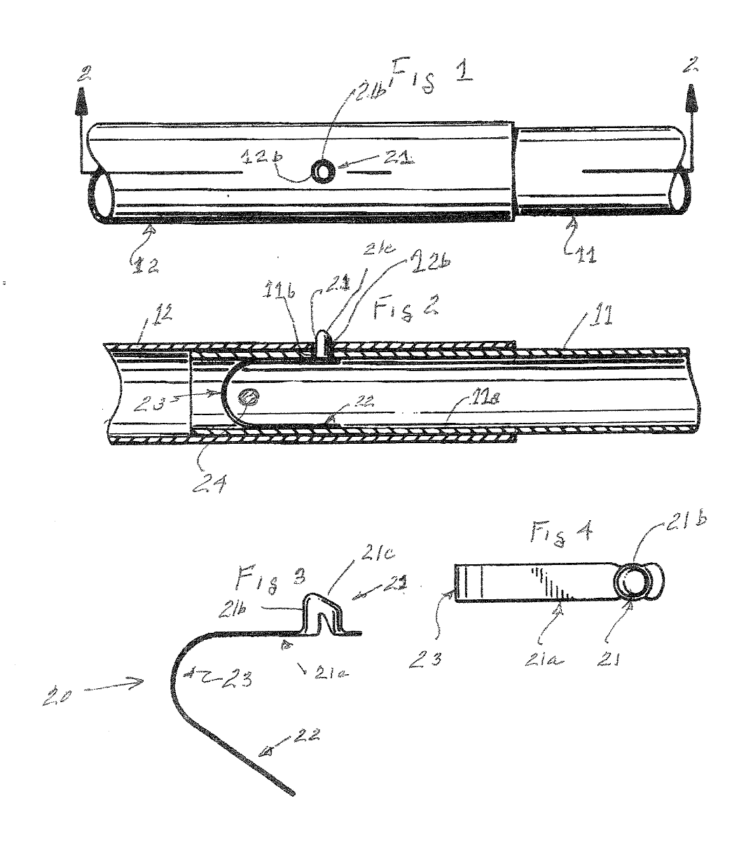

### DESCRIPTION OF A PREFERRED EMBODIMENT OF THE INVENTION

In accordance with the accompanying drawings, the spring loaded detent embodying the concepts of the applicant's invention is generally designated, in its entirety 20 and is illustrated in a use position to releasably hold two tubular members together. Although two tubular members 11, 12 are illustrated, it should be obvious that the detent 20, having an active portion 21 and a biasing portion 22, having an arcuately formed joining section 21, may be utilized in releasably joining members of other shapes and configurations although it is necessary to provide a reactive surface, such as a spaced surface 11a, opposite the opening 11b through which the active detent portion 21 is operative to force such active detent portion 21 through aperture or opening 11b of the first member 11, into and through a receiving aperture 12b on the joined member 12. In this manner, the elements are releasably joined.

As an example, plates could be joined if a bracket were provided on a first plate against which the biasing portion 22 of the detent unit 21 would function with its active detent 21 protruding through a hole in the plate and the second plate would be placed thereover with a detent receiving aperture therein.

Therefore, it should be obvious that the joinder capacities of the invention are not limited to tubular members.

As illustrated, the detent unit 20 consists of a first arm, biasing portion 22 which is normally abutted against a surface such as the inner wall of tubular member 11, the arcuate connective portion 23 to connect to the first, detent bearing arm 21a and the detent itself 21. As particularly illustrated in FIGS. 3 and 4, the second arm 21a and detent 21 are formed from a singular member through a single operation such as pressing or forging. The detent 21 primarily consists of a generally circular, upstanding body member 21b providing an upper surface upon which an angled, downwardly depending surface 21c is formed. This surface includes a major portion of the upper surface allowing a domed section adjacent the upper end of the angled surface 21c.

It is this combination of upstanding body 21b and the combination domed and angled top surface 21c that is essential for reduced introduction and removal forces for the two joined members.

It should also be understood that, although the angled surface 21c is illustrated as being directed toward the free end of arm 21a, it may be directed toward the arcuate arm connecting portion 23 without departing from the scope of the invention.

With the selected, angled surface 21c, it is only necessary to introduce detent 21 into the aperture 12b of the member to be joined and continue the connection by a slight longitudinal motion which, due to the biasing of the detent 20, will drive the detent 20 into locked position. Similarly to disconnect the joined members, it is only necessary to exert a minimal inward or downward force against the top surface of the detent to introduce the angled surface into the opening 12b and thereafter a longitudinal force will force the detent inwardy from locking position. This will be true whether the angled surface 21c is as shown or in the opposite, explained configuration.

The particular angle of the surface 21 is not highly critical but the applicant has found that the angularity thereof may be determined from the thickness of the member to be joined. The entire body height should pass through the thickness of the second member to the point that the angled surface meets the outer thickness of such member while the opposite side of the body will extend therebeyond. The opposite, non-angled side of the body will, at this point extend beyond the second body thickness as illustrated in FIG. 2.

In addition to the above, the applicant has found that, in some situations, the addition of a detent retaining pin 24 transversely arranged across the interior the first connected member 11 will positively maintain the entire detent unit 20 within the first such member 11. This will depend upon many factors including the force required to retain the members 11, 12 in their joined position, the material from which the members 11, 12 are fabricated and the like. This pin 24 is simply a device to retain the detent 20 in an operative position.

It should be obvious that the applicant has provided a detent unit that, through its specific angled shape, will insure positive and most importantly the simplicity and force reduction aspects of joining and releasing members that require positive locking therebetween.

What is claimed is:

1. A spring loaded detent for the releasably joining of two members such as tubular members, including;
a. a pair of arms joined through an arcuate joinder section such that an outwardly directed biasing force is provided by forcing such arms towards one another;
b. a first of such arms carrying a detent thereon extending outward from the same;
c. the detent arranged and constructed to be carried by a first of the members with the detent arranged to pass and extend through an aperture of the first member;
d. the detent having a generally circular body with a top surface and having a body length to extend into and through an aperture formed in the second member to be joined; and,
e. said top surface of said detent being angularly formed downwardly from the top surface thereof such that the lower edge of such angled surface meets the outer dimension of the second member to be joined as the remaining portion of said body extends through the thickness of the second member.

2. The spring loaded detent as set forth in claim 1 and said detent having a generally circular body.

3. The spring loaded detent as set forth in claim 1 and said detent and said arms being integrally formed.

4. The spring loaded detent as set forth in claim 1 and a transverse pin member arrnaged to extend across at least a portion of said first member to retain the detent therein
